(19) United States
(12) Patent Application Publication
(10) Pub. No.: US 2009/0099767 A1
(43) Pub. Date: Apr. 16, 2009

(54) Light stripe detection method for indoor navigation and parking assist apparatus using the same

(75) Inventor: Ho-gi Jung, Seoul (KR)

Correspondence Address: HARNESS, DICKEY & PIERCE, P.L.C., P.O. BOX 828, BLOOMFIELD HILLS, MI, 48303, US

(73) Assignee: Mando Corporation

(21) Appl. No.: 12/287,494

(22) Filed: Oct. 9, 2008

(30) Foreign Application Priority Data
Oct. 10, 2007 (KR) 10-2007-0102053

(51) Int. Cl. G01C 21/20; G08G 1/16

(52) U.S. Cl. 701/200; 701/301

(57) ABSTRACT

Disclosed is a method for detecting a light stripe for indoor navigation and a parking assist apparatus using the same. The apparatus applies light plane projection to indoor navigation, detects a light stripe from an image inputted through a camera, detects an obstacle, and assists vehicle parking by using an active steering device and an electronically controlled braking device. A light stripe width function is used to calculate a light stripe width, and a half value of the calculated light stripe width is used as a constant value of a LOG filter to conduct LOG filtering and detect the light stripe. The precision and rate of recognition of light stripes obtained by LOG filtering are advantageously improved. Therefore, obstacles are precisely recognized during indoor navigation, and parking is assisted efficiently.

### BACKGROUND OF THE INVENTION

1. Field of the Invention

The present invention relates to a light stripe detection method for indoor navigation and a parking assist apparatus using the same. More particularly, the present invention relates to a method for improving the performance of recognizing three-dimensional information from light plane projection by accurately finding a large number of centers of light stripes in an indoor navigation environment (e.g. automatic parking in an underground parking lot) so that three-dimensional information regarding indoor navigation environments is detected more precisely in more positions, and a parking assist apparatus using the same.

2. Description of the Prior Art

1.1 Three-Dimensional Information Recognition by Light Plane Projection

Light plane projection refers to technology for recognizing three-dimensional information by projecting a light plane from a light plane projector so that stripes created in the objects are used to recognize three-dimensional information.

FIG. 1 is an exemplary diagram for describing the process of recognizing three-dimensional information by using light plane projection.

In FIG. 1, ‘O’ denotes the optical center of a camera, ‘x-y plane’ denotes an image plane, ‘b’ denotes the distance between the optical center O and a light plane projector along the y-axis of the camera, and Po denotes the position of the light plane projector. In addition, Π denotes a light plane created by the light plane projector.

It is assumed that the light plane Π crosses the Y-axis at a point Po(0, −b, 0), the included angle between the light plane Π and the Y-axis is α, and the included angle between the light plane and the X-axis is ρ. Then, illumination of an object by the light plane projector creates a laser stripe. A point on the image plane corresponding to a point P(X, Y, Z) of the laser stripe is indicated by p(x, y), and the coordinate of P is measured by using the point of intersection between the plane Π and the straight line 0p. Assuming that the light plane is substantially parallel to the X-axis of the camera, only one light stripe is created for each image column.

1) Equation on Light Plane Π

The normal vector of the XZ plane, i.e. (0, 1, 0), is rotated by π/2-α with respect to the X-axis, and is rotated by ρ with respect to the Z-axis to obtain the normal vector n of the light plane Π, which is defined by Equation (1) below.

$$\begin{matrix}n = [ \begin{matrix}cos ρ & sin ρ & 0 \\ - sin ρ & cos ρ & 0 \\ 0 & 0 & 1\end{matrix} ] [ \begin{matrix}1 & 0 & 0 \\ 0 & cos ( \frac{π}{2} - α ) & sin ( \frac{π}{2} - α ) \\ 0 & - sin ( \frac{π}{2} - α ) & cos ( \frac{π}{2} - α )\end{matrix} ] [ \begin{matrix}0 \\ 1 \\ 0\end{matrix} ] \\ = [ \begin{matrix}sin α \cdot sin ρ \\ sin α \cdot cos ρ \\ - cos α\end{matrix} ]\end{matrix} \qquad ( 1 )$$

The equation of the light plane Π is obtained by using the normal vector n of Equation (1) and a point Po on the light plane, as defined by Equation (2) below.

n(X−P₀)=0 (2)

2) Obtaining a Point P on the Laser Stripe

The optical center O, a point p on the image plane, and a corresponding point P in the three-dimensional space all lie on the same straight line. By using a perspective camera model defined by Equation (3) below, every point Q on the straight line can be expressed by using a parameter k, as defined by Equation (4) below, wherein f denotes a focal length.

$$\begin{matrix}\frac{X}{χ} = \frac{Z}{f} = \frac{Y}{y} & ( 3 ) \\ Q = ( k \cdot x , k \cdot y , k \cdot f ) & ( 4 )\end{matrix}$$

In this case, a point P on the laser stripe is a point of intersection between the light plane Π and the straight line Op, and satisfies both Equations (2) and (4). Therefore, when Equations (4) and (1) are substituted for Equation (2), parameter k is derived as defined by Equation (5) below.

$$[ \begin{matrix}sin α \cdot sin ρ & sin α \cdot cos ρ & - cos α\end{matrix} ] [ \begin{matrix}k \cdot x \\ k \cdot y \\ k \cdot f\end{matrix} ] = [ \begin{matrix}sin α \cdot sin ρ & sin α \cdot cos ρ & - cos α\end{matrix} ] [ \begin{matrix}0 \\ - b \\ 0\end{matrix} ] \\ k ( sin α ( x \cdot sin ρ + y \cdot cos ρ ) - f \cdot cos α ) = - b \cdot sin α \cdot cos ρ \\ k = \frac{b \cdot sin α \cdot cos ρ}{f \cdot cos α - sin α ( x \cdot sin ρ + y \cdot cos ρ )} = \frac{b \cdot tan α \cdot cos ρ}{f - tan α ( x \cdot sin ρ + y \cdot cos ρ )} \qquad ( 5 )$$

Furthermore, when Equation (5) is substituted for Equation (4), the coordinate of point P is obtained as defined by Equations (6), (7), and (8) below.

$$\begin{matrix}X = \frac{x \cdot b \cdot tan α \cdot cos ρ}{f - tan α ( x \cdot sin ρ + y \cdot cos ρ )} & ( 6 ) \\ Y = \frac{y \cdot b \cdot tan α \cdot cos ρ}{f - tan α ( x \cdot sin ρ + y \cdot cos ρ )} & ( 7 ) \\ Z = \frac{f \cdot b \cdot tan α \cdot cos ρ}{f - tan α ( x \cdot sin ρ + y \cdot cos ρ )} & ( 8 )\end{matrix}$$

Particularly, when the light plane and the X-axis are parallel to each other (that is, ρ is 0), Equations (6), (7), and (8) can be simplified into Equations (9), (10), and (11), respectively. It is to be noted that the distance Z between the camera and a point P on the object has a one-to-one relationship with the y-coordinate of the point on the image.

$$\begin{matrix}X = \frac{x \cdot b \cdot tan α}{f - y \cdot tan α} & ( 9 ) \\ Y = \frac{y \cdot b \cdot tan α}{f - y \cdot tan α} & ( 10 ) \\ Z = \frac{f \cdot b \cdot tan α}{f - y \cdot tan α} & ( 11 )\end{matrix}$$

1.2 Line Segment Detection Based on LOG (Laplacian of Gaussian)

LOG or Mexican Hat Wavelet is a filter most frequently used to detect line segments in the field of computer vision.

FIG. 2 is an exemplary graph illustrating a Mexican Hat Wavelet function.

LOG, defined by Equation (12) below, is a normalized second derivative of a Gaussian function. LOG is also a combination of a Gaussian LPF (Low Pass Filter) and peak enhancement, and the size of the result of convolution with LOG is proportional to the possibility that the inputted image is a line.

$$ψ ( t ) = \frac{1}{\sqrt{2 π} \cdot {σ}^{3}} ( 1 - \frac{{t}^{2}}{{σ}^{2}} ) \cdot exp ( - \frac{{t}^{2}}{2 {σ}^{2}} ) \qquad ( 12 )$$

wherein, σ determines the position of a zero crossing point that corresponds to the line width. If σ smaller than the actual line width is used, a point is detected from the periphery of the stripe rather than from the center. If σ much smaller than the actual line width is used, the strong low pass filter effect ignores the line. Considering that each column has only one light stripe, the light surface projector conducts one-dimensional LOG filtering with regard to each column and recognizes a point exhibiting the largest output as the stripe.

1.3 Configuration of Radiance Map by Means of HDRi (High Dynamic Range Imaging)

Exposure X is defined as a product of irradiance E and exposure time t. Intensity Z is expressed as a nonlinear function regarding exposure X, as defined by Equation (13) below.

X=f⁻¹(Z) (13)

Taking logarithm of both sides of Equation (13) gives Equation (14), and defining function g as log f⁻¹ gives Equation (15).

log f⁻¹(Zᵢⱼ)=log Eᵢ+log tⱼ (14)

g(Zᵢⱼ)=log Eᵢ+log tⱼ (15)

wherein, i refers to an index regarding a pixel coordinate, and j refers to an index regarding exposure time during photography. A nonlinear function defining the relationship between exposure X and intensity Z is referred to as a response curve of the imaging system.

Debevec has defined in Equation (16) a standard for making the response curve smooth while minimizing the error of pixels with regard to Equation (15), and has presented an estimation method based on LS (Least Square) method. This means that, by photographing a scene while varying the exposure time, the response curve of the sensor and the radiance map of the scene can be obtained.

$$O = {\sum }_{i = 1}^{N} {\sum }_{j = 1}^{P} {[ g ( {Z}_{ij} ) - log {E}_{i} - log {t}_{j} ]}^{2} + λ {\sum }_{z = {Z}_{min} + 1}^{{Z}_{max} - 1} {{g}^{″} ( z )}^{2} \qquad ( 16 )$$

### SUMMARY OF THE INVENTION

Accordingly, the present invention has been made to solve the above-mentioned problems occurring in the prior art, and the present invention provides a method for improving the performance of recognizing three-dimensional information from light plane projection by accurately finding a large number of centers of light stripes in an indoor navigation environment (e.g. automatic parking in an underground parking lot) so that three-dimensional information regarding indoor navigation environments is detected more precisely in more positions, and a parking assist apparatus using the same.

In accordance with an aspect of the present invention, there is provided an apparatus for assisting parking by applying light plane projection to indoor navigation, detecting a light stripe from an image inputted through a camera, detecting an obstacle, and assisting vehicle parking by using an active steering device and an electronically controlled braking device, wherein a light stripe width function is used to calculate a light stripe width, and a half value of the calculated light stripe width is used as a constant value of a LOG (Laplacian of Gaussian) filter to conduct LOG filtering and detect the light stripe.

In accordance with another aspect of the present invention, there is provided a method for detecting a light stripe inputted through a camera based on application of light plane projection to indoor navigation by a parking assist apparatus connected to a camera, an active steering device, and an electronically controlled braking device to assist vehicle parking, the method including the steps of (a) configuring a light stripe radiance map by using an input image from the camera; (b) modeling a parameter of the light stripe radiance map into a function of a distance from the camera to an obstacle; (c) calculating a light stripe width function by using the parameter of the light stripe radiance map; (d) calculating a light stripe width by using the light stripe width function; and (e) detecting the light stripe by using ½ size of the light stripe width as a constant of a LOG filter and conducting LOG filtering.

As described above, the present invention is advantageous in that it can improve the rate and precision of recognition of light stripes obtained through LOG filtering. As a result, obstacles are precisely recognized during indoor navigation, and parking is assisted efficiently.

### BRIEF DESCRIPTION OF THE DRAWINGS

The above and other objects, features and advantages of the present invention will be more apparent from the following detailed description taken in conjunction with the accompanying drawings, in which:

FIG. 1 is an exemplary diagram for describing the process of recognizing three-dimensional information by using light plane projection;

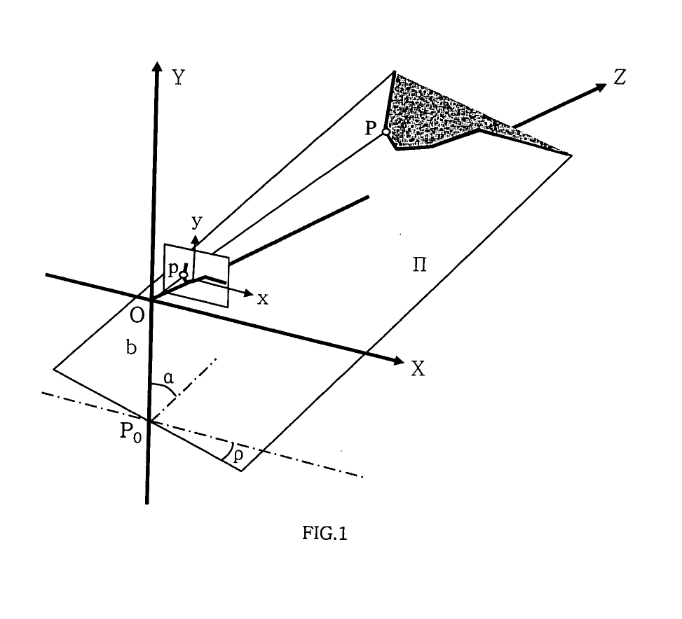

FIG. 2 is an exemplary graph showing a Mexican hat wavelet function;

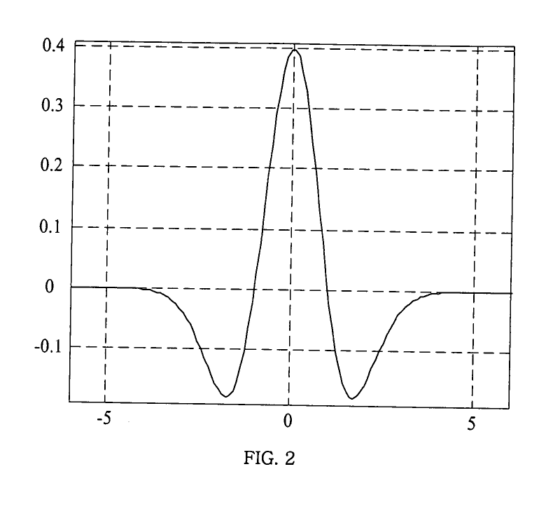

FIG. 3 is an exemplary graph showing a response curve obtained from an experiment;

FIG. 4 is an exemplary diagram showing the process of obtaining a radiance map of a light stripe;

FIG. 5 is an exemplary diagram showing a light stripe radiance map described by estimated parameters;

FIG. 6 is an exemplary diagram showing the result of modeling estimated parameters into equations;

FIG. 7 is an exemplary diagram showing a measured light stripe width and a calculated light stripe width;

FIG. 8 is an exemplary diagram showing a light stripe width measured from each pixel of an image and a calculated light stripe width;

FIG. 9 is an exemplary image showing the result of calculating the light stripe width with regard to every pixel of an image;

FIG. 10 is an exemplary diagram showing the advantageous effect of a method for detecting light stripes according to an embodiment of the present invention;

FIG. 11 is a block diagram showing the brief construction of a parking assist apparatus using light stripe detection according to an embodiment of the present invention; and

FIG. 12 is a flowchart describing a method for detecting a light stripe for indoor navigation according to an embodiment of the present invention.

### DETAILED DESCRIPTION OF THE EXEMPLARY EMBODIMENTS

Hereinafter, exemplary embodiments of the present invention will be described with reference to the accompanying drawings. In the following description and drawings, the same reference numerals are used to designate the same or similar components, and so repetition of the description on the same or similar components will be omitted. Furthermore, a detailed description of known functions and configurations incorporated herein is omitted to avoid making the subject matter of the present invention unclear.

2.1 Approximation of Camera Response Curve

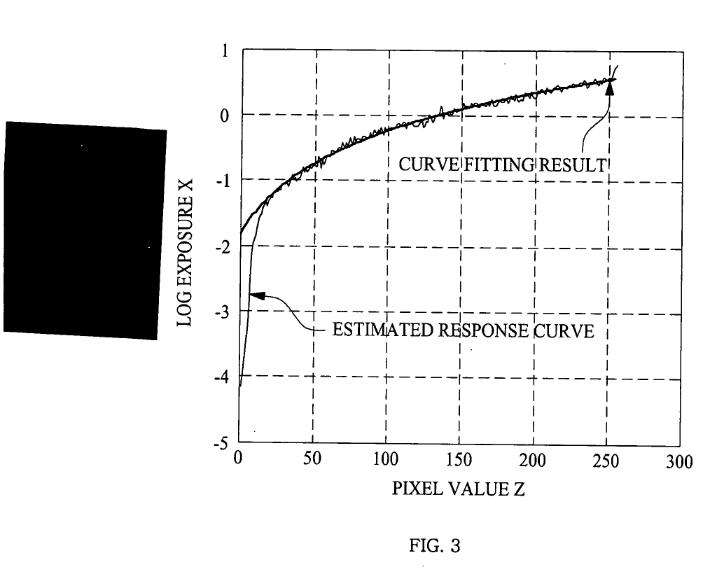

FIG. 3 is an exemplary graph showing a response curve obtained from an experiment.

A response curve of a camera is obtained by using HDRi (High Dynamic Range Imaging). A response curve obtained from an experiment has noise as shown in FIG. 3, and a modeled response curve, defined by Equation (17) below, is used. Parameters of Equation (17) are estimated by using LS (Least Square) method.

log(A_{rc}Z+B_{rc})=log(X) (17)

2.2 Obtaining Radiance Map of Light Stripe

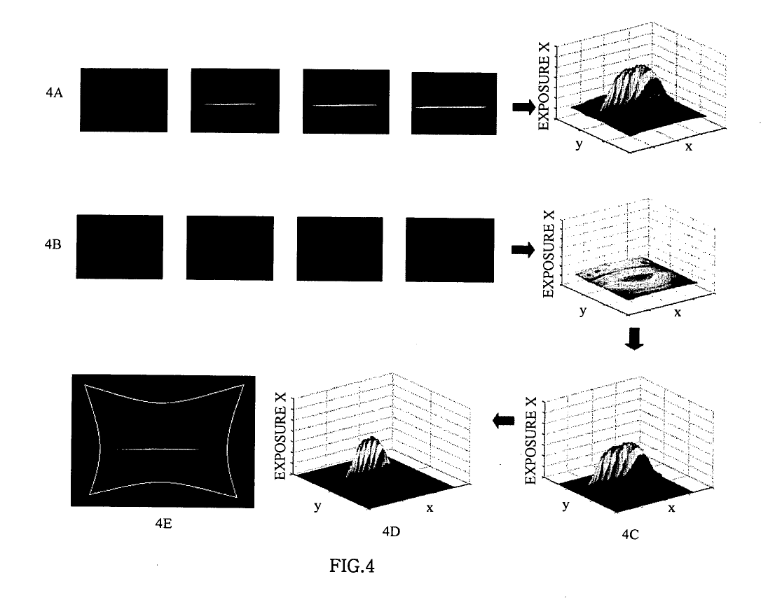

FIG. 4 is an exemplary diagram showing the process of obtaining the radiance map of a light stripe.

Particularly, FIG. 4A shows the process of configuring a light stripe radiance map by varying the exposed image when a light plane projector has been turned on. FIG. 4B shows the process of configuring a light stripe radiance map by varying the exposed image when the light plane projector has been turned off. FIG. 4C shows the final light stripe radiance map. FIG. 4D shows the light stripe radiance map after correcting distortion. FIG. 4E shows an image into which the light stripe radiance map after distortion correction is converted.

As shown in the drawing, the light plane projector is turned on, and the exposure time is varied to obtain images. HDRi is applied to the obtained images to configure a radiance map. Then, the light plane projector is turned off, and the exposure time is varied to obtain images. HDRi is applied to the obtained images to configure another radiance map. The difference between both radiance maps obtained in this manner corresponds to the radiance map of a light stripe.

A wide-angle lens is generally used for indoor navigation. Therefore, radial distortion parameters are estimated through a preceding calibration process, and radial distortion is eliminated based on the estimation.

2.3 Two-Dimension Gaussian Modeling of Light Stripe Radiance Map

A radiance map of a light stripe follows two-dimensional Gaussian distribution, as defined by Equation (18) below.

$$E ( x , y ) = \frac{K}{2 π \cdot {σ}_{x} {σ}_{y}} exp ( - \frac{1}{2} ( \frac{{( x - {μ}_{x} )}^{2}}{{σ}_{x}^{2}} + \frac{{( y - {μ}_{y} )}^{2}}{{σ}_{y}^{2}} ) ) \qquad ( 18 )$$

Definition of two-dimensional Gaussian distribution requires estimation of five parameters, including amplitude K, means (μₓ,μ_{y}), and standard deviations with regard to respective axes (σₓ,σ_{y}). The parameters are obtained by estimating y-axis distribution by LS method and then x-axis distribution.

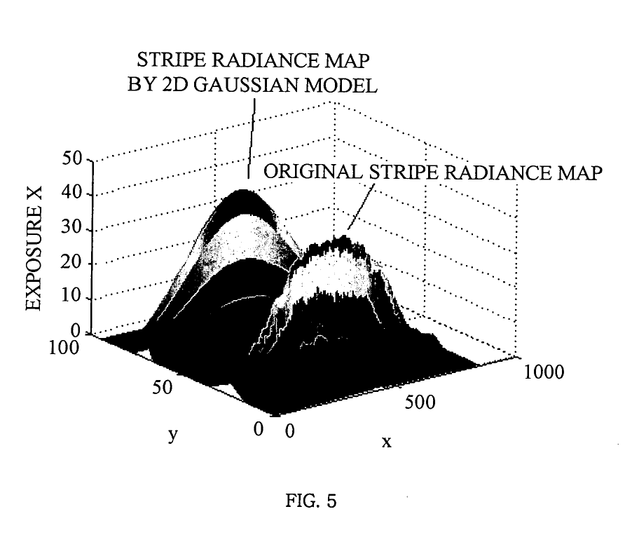

FIG. 5 is an exemplary diagram showing a light stripe radiance map described by estimated parameters.

It is clear from FIG. 5 that the estimated parameters well describe the measured light stripe radiance map.

If the light stripe projector and the camera change the distance d to the obstacle, the means among the two-dimensional Gaussian parameters do not change, but K, σₓ, and σ_{y} can be modeled into functions regarding distance d, as defined by Equations (19), (20), and (21) below, respectively.

$$\begin{matrix}K ( d ) = \frac{{a}_{average}}{{d}^{2}} & ( 19 ) \\ {σ}_{x} ( d ) = \frac{{a}_{xy}}{{d}^{2}} + {b}_{xy} & ( 20 ) \\ {σ}_{y} ( d ) = \frac{{a}_{xy}}{d} + {b}_{xy} & ( 21 )\end{matrix}$$

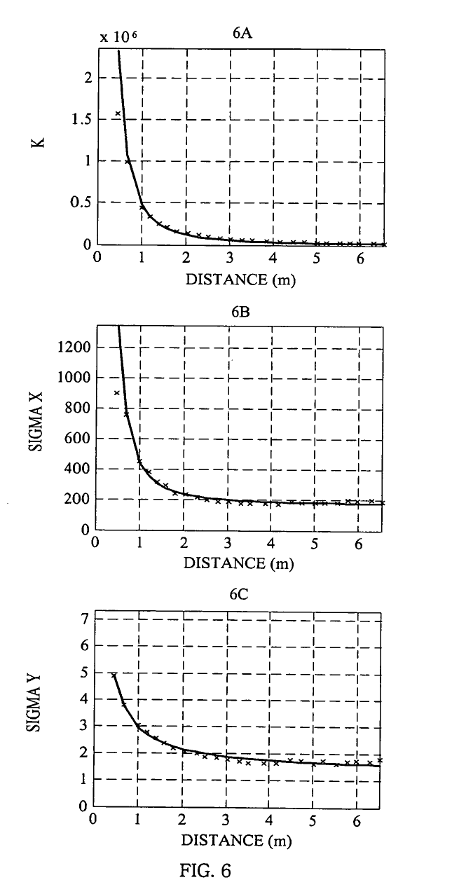

FIG. 6 is an exemplary diagram showing the result of modeling estimated parameters into equations.

Particularly, FIG. 6A shows measured K, FIG. 6B shows measured σₓ, and FIG. 6C shows measured σ_{y}. The drawings show the results of modeling K, σₓ, and σ_{y}, and into Equations (19), (20), and (21), respectively.

2.4 Light Stripe Width Function

Supposing that a light stripe width is the length of an area larger than intensity difference θ_{z} with regard to the periphery, the intensity difference θ_{z} can be converted into irradiance difference θ_{E} by Equation (15). Substituting the irradiance difference θ_{E} for Equation (18), taking logarithm, and arranging the equation gives Equation (22) below.

$${( y - {μ}_{y} )}^{2} = 2 {σ}_{y}^{2} ( log \frac{K}{2 π \cdot {σ}_{x} {σ}_{y}} - \frac{1}{2} \frac{{( x - {μ}_{x} )}^{2}}{{σ}_{x}^{2}} - log {θ}_{E} ) \qquad ( 22 )$$

In the case of light plane projection, a light stripe appears only once for each column of an image, and follows one-dimensional Gaussian distribution along the y-axis.

Accordingly, it is clear that a y-coordinate satisfying θ_{E} (Equation (22)) is the y-coordinate of the boundary of the light stripe, and has the largest irradiance value at the mean, and that twice the distance between the y-coordinate of the boundary and the mean is the light stripe width.

Substituting Equations (19), (20), and (21), which give modeling of K, σₓ, σ_{y} with regard to distance d, respectively, for Equation (22) gives a light stripe function w(x, d) with regard to the x-coordinate of the image, x, and distance d, as defined by Equation (23) below.

$$w ( x , d ) = 2 \sqrt{2 {{σ}_{y} ( d )}^{2} ( log \frac{K ( d )}{2 π \cdot {σ}_{x} ( d ) \cdot {σ}_{y} ( d )} - \frac{1}{2} \frac{{( x - {μ}_{x} )}^{2}}{{{σ}_{x} ( d )}^{2}} - log {θ}_{E} )} \qquad ( 23 )$$

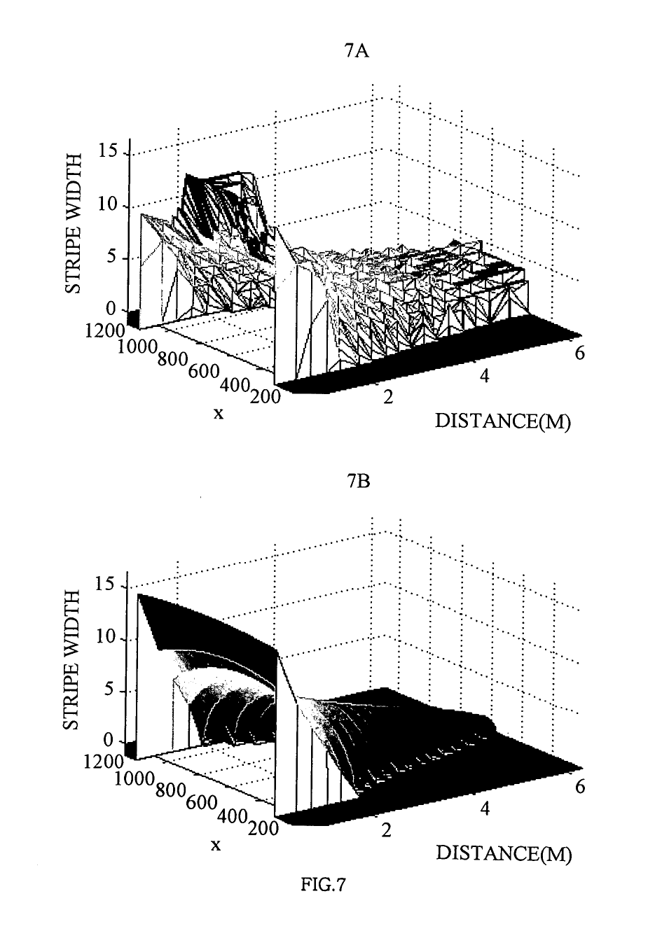

FIG. 7 is an exemplary diagram showing a measured light stripe width and a calculated light stripe width.

Particularly, FIG. 7A shows an actually measured light stripe width, and FIG. 7B shows a light stripe width calculated by Equation (23).

In the case of light stripe projection, the distance d (Z in the world coordinates system) has a one-to-one relationship with the y-coordinate of an image as defined by Equation (11). Therefore, w(x, d) in Equation (23) can be converted into a light stripe width function w(x, y) with regard to the coordinate (x, y) on the image, as defined by Equation (24) below.

$$w ( x , y ) = w ( x , d = \frac{f \cdot b \cdot tan α}{f - y \cdot tan α} ) \qquad ( 24 )$$

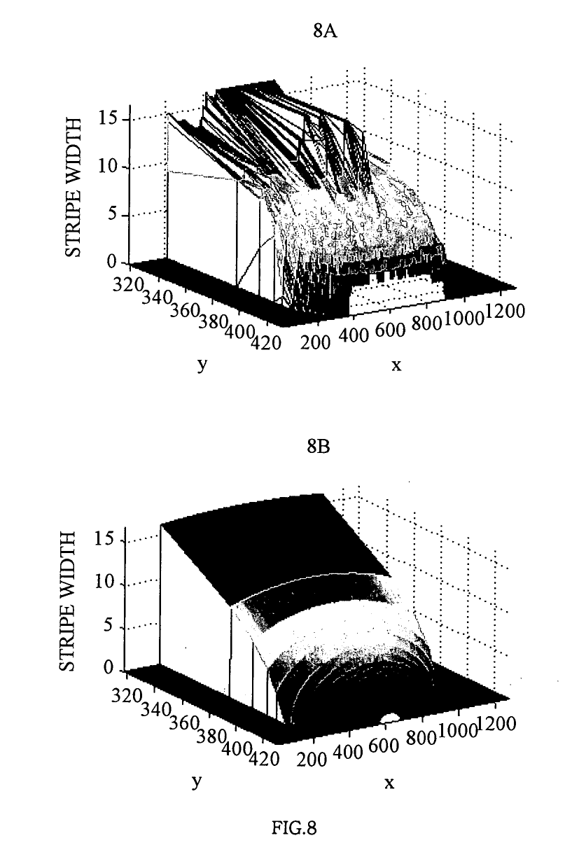

FIG. 8 is an exemplary diagram showing a light stripe width measured from each pixel of an image and a calculated light stripe width.

Particularly, FIG. 8A shows a light stripe width measured from each pixel (x, y) of an image, and FIG. 8B shows a light stripe width calculated by Equation (24).

The configuration of light plane projection is fixed, and the parameter function of two-dimensional Gaussian distribution of a light stripe radiance map regarding a painted wall, which is a main object of indoor navigation, is estimated in advance. Then, the width of a light stripe that is supposed to appear at the image coordinate (x, y) can be estimated.

In the case of indoor navigation such as driving in an underground parking lot, for example, peripheral obstacles are usually painted walls and have comparatively uniform reflective characteristics. Thus, it will be assumed hereinafter that an obstacle has a homogeneous lambertian surface, and that a light stripe radiance map can be modeled into two-dimensional Gaussian distribution.

The amplitude of a two-dimensional Gaussian model, as well as x-axis and y-axis Gaussian distribution, is a function of distance, and parameters of this function can be estimated through preceding calibration. Regarding intensity threshold θ_{z} for distinguishing a stripe from the background, a light stripe width function can be defined by Equations (23) and (24), and the light stripe width regarding the pixel coordinate (x, y) can be calculated in advance.

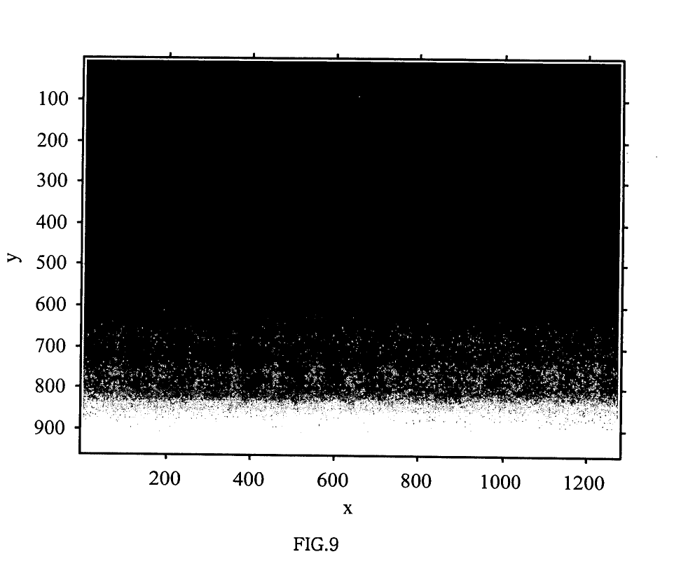

FIG. 9 is an exemplary image showing the result of calculating the light stripe width with regard to every pixel of an image.

Assuming that a LOG filter (Equation (12)) is used to detect a light strip in connection with application of light source projection to indoor navigation, the ½ size of the light stripe width obtained by Equations (22) and (23) is used as σ of the LOG filter. This improves the precision and rate of recognition of a light stripe obtained by LOG filtering.

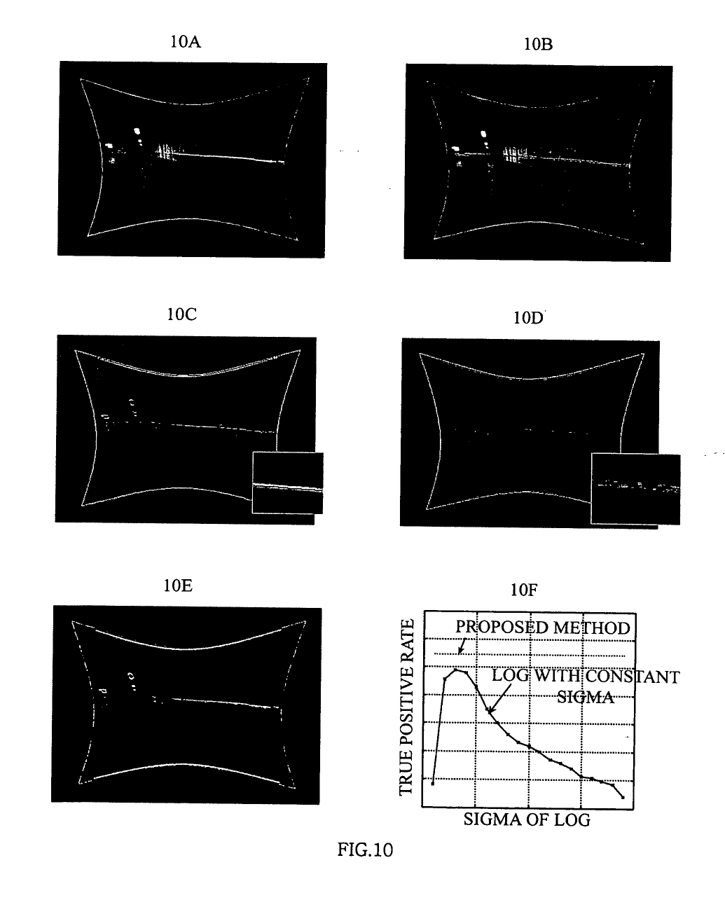

FIG. 10 is an exemplary diagram showing advantageous effects of a method for detecting light stripes according to an embodiment of the present invention.

Particularly, FIG. 10A shows an input image, FIG. 10B shows a reference light stripe, and FIG. 10C shows the result of detecting light stripes according to an embodiment of the present invention. It is clear from FIG. 10C that light stripes have been detected accurately both at a near place having thick light stripes and at a distant place having thin light stripes.

FIG. 10D shows a LOG result when σ is 1. It is clear from FIG. 10D that, when a small constant σ is used, the result is sensitive to noise, and the center of thick light stripes cannot be found. FIG. 10E shows a LOG result when σ is 5. It is clear from FIG. 10E that, when a large constant σ is used, thin light stripes in the distance are ignored, and line segments on the bottom are recognized as light stripes.

FIG. 10F shows a performance comparison between the result obtained by a light stripe detecting method according to an embodiment of the present invention and the result of change of constant σ.

Particularly, FIG. 10F shows a comparison between a recognition result obtained by a light stripe detecting method according to an embodiment of the present invention and a reference light stripe, as well as a comparison between a recognition result obtained by changing σ of LOG, which uses constant σ, and the reference light stripe.

The comparisons show that, when the distance to the obstacle is varied as in the case of the experiment, the light stripe detecting method according to an embodiment of the present invention is superior to any recognition method using the same σ.

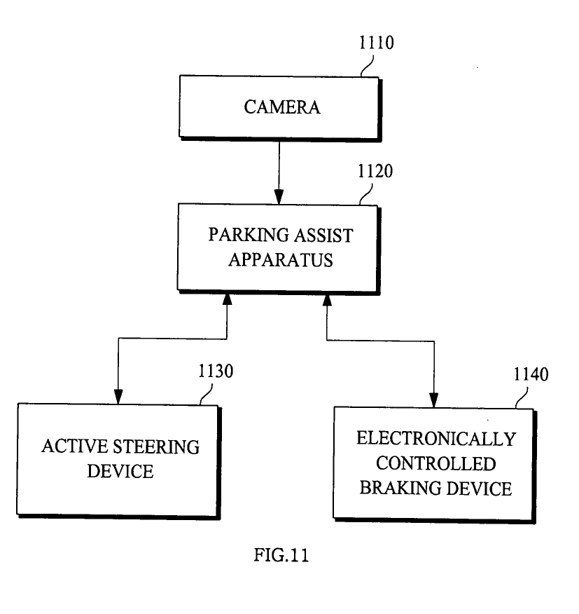

FIG. 11 is a block diagram showing the brief construction of a parking assist apparatus using light stripe detection according to an embodiment of the present invention.

The parking assist apparatus 1120 using light stripe detection according to an embodiment of the present invention is connected to a camera 110, an active steering device 1130, and an electronically controlled braking device 1140 to detect obstacles in the surroundings by using images inputted from the camera and to steer and brake the vehicle by using the active steering device 1130 and the electronically controlled braking device 1140, thereby assisting vehicle parking.

The active steering device 1130 refers to a steering assist means for recognizing the driving condition and the driver's intention and assisting the steering. The active steering device 1130 includes EPS (Electronic Power Steering), MDPS (Motor Driven Power Steering), AFS (Active Front Steering), etc.

The electronically controlled braking device 1140 refers to a braking control means for changing the braking condition of the vehicle, and includes an ABS (Anti-lock Brake System), an ASC (Automatic Stability Control) system, a DSC (Dynamic Stability Control) system, etc.

The parking assist apparatus 1120 according to an embodiment of the present invention applies light surface projection to indoor navigation, detects light stripes from images inputted through the camera, detects obstacles based on the light stripes, and assists vehicle parking.

When detecting light stripes, the parking assist apparatus 1120 according to an embodiment of the present invention uses a light stripe width function to calculate the light stripe width, the half value of which is used as a constant of the LOG (Laplacian of Gaussian) filter to detect light stripes.

When modeling a light stripe radiance map into two-dimensional Gaussian distribution in connection with light surface projection, the parking assist apparatus 1120 according to an embodiment of the present invention models parameters of the light stripe radiance map into functions of the distance from the camera to the obstacle.

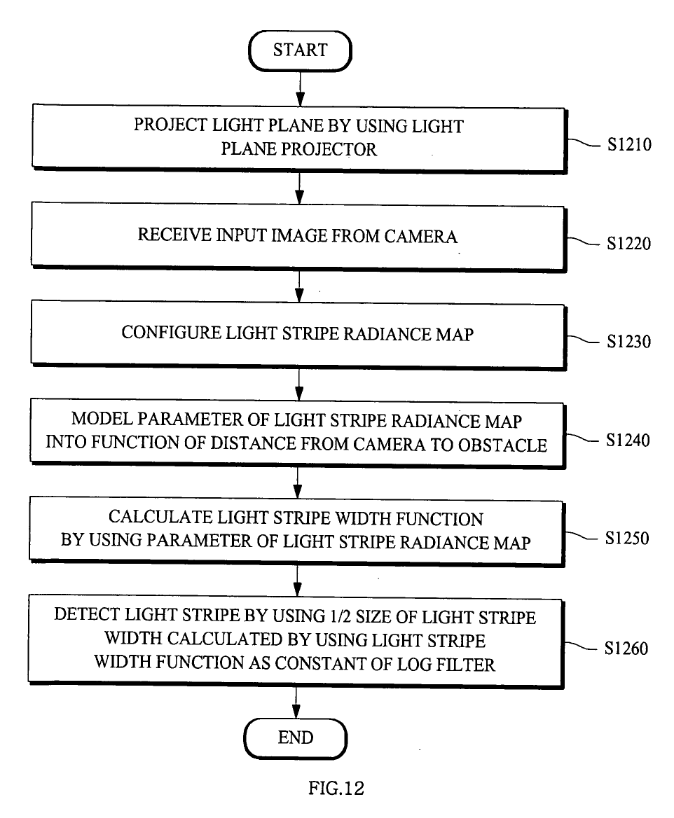

FIG. 12 is a flowchart describing a method for detecting light stripes for indoor navigation according to an embodiment of the present invention.

The parking assist apparatus 1120 described with reference to FIG. 11 assists the driving or parking of a vehicle by detecting obstacles in an indoor navigation environment (e.g. an underground parking lot). To this end, light surface projection is applied to indoor navigation to detect light stripes and obstacles.

Particularly, the parking assist apparatus 1120 projects a light plane onto the indoor navigation environment by using a light plane projector mounted on the camera 110 (S1210), receives an input image from the camera 110 (S1220), and configures a light stripe radiance map from the input image (S1230).

After configuring the light stripe radiance map, the parking assist apparatus 1120 models parameters of the light stripe radiance map into functions of the distance between the camera to the obstacle (S1240), and calculates a light stripe width function by using the modeled parameters of the modeled light stripe radiance map (S1250).

The parking assist apparatus 1120 calculates the light stripe width by using the light stripe width function, and detects light stripes by using the ½ size of the calculated light stripe width as a constant (i.e. σ) of the LOG filter for detecting line segments (S1260).

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An apparatus for assisting parking by applying light plane projection to indoor navigation, detecting a light stripe from an image inputted through a camera, detecting an obstacle, and assisting vehicle parking by using an active steering device and an electronically controlled braking device, wherein
a light stripe width function is used to calculate a light stripe width, and a half value of the calculated light stripe width is used as a constant value of a LOG (Laplacian of Gaussian) filter to conduct LOG filtering and detect the light stripe.

2. The apparatus as claimed in claim 1, wherein, when a light stripe radiance map is modeled into two-dimensional Gaussian distribution in connection with light surface projection, the apparatus models a parameter of the light stripe radiance map into a function of a distance from the camera to the obstacle.

3. The apparatus as claimed in claim 1, wherein the light stripe width function is calculated by using an intensity threshold for distinguishing the light stripe from a background.

4. A method for detecting a light stripe inputted through a camera based on application of light plane projection to indoor navigation by a parking assist apparatus connected to a camera, an active steering device, and an electronically controlled braking device to assist vehicle parking, the method comprising the steps of:
(a) configuring a light stripe radiance map by using an input image from the camera;
(b) modeling a parameter of the light stripe radiance map into a function of a distance from the camera to an obstacle;
(c) calculating a light stripe width function by using the parameter of the light stripe radiance map;
(d) calculating a light stripe width by using the light stripe width function; and
(e) detecting the light stripe by using a ½ size of the light stripe width as a constant of a LOG filter and conducting LOG filtering.
